(19) United States
(12) Patent Application Publication
(10) Pub. No.: US 2010/0098038 A1
(43) Pub. Date: Apr. 22, 2010

(54) DEPLOY APPARATUS, METHOD, AND COMPUTER PROGRAM PRODUCT THEREOF FOR A WIRELESS NETWORK

(75) Inventors: Jiun-Jian CHANG, Jhubei City (TW); Pi-Cheng HSIU, Kaohsiung City (TW); Tei-Wei KUO, Banqiao City (TW); Hua-Wei FANG, Kaohsiung City (TW); David M. Di, Banqiao City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, TAIPEI (TW)

(21) Appl. No.: 12/354,384

(22) Filed: Jan. 15, 2009

(30) Foreign Application Priority Data
Oct. 21, 2008 (TW) 097140278

(51) Int. Cl. H04W 4/00

(52) U.S. Cl. 370/338

(57) ABSTRACT

A deploy apparatus, method and computer program product thereof for a wireless network are provided. The wireless network comprises at least one first network node and a second network node. The method comprises the following steps: calculating an output constant and a node constant according to a first default value, a second default value and a third default value; calculating a first evaluation function according to the related information of the network nodes of the wireless network; moving or removing the second network node from the wireless network when the output constant is smaller than one and a test value is smaller than the node constant; calculating a second evaluation function according to the related information of the network nodes of the wireless network; and deploying the wireless network after comparing the first evaluation function and the second evaluation function.

This application claims the benefit of priority based on Taiwan Patent Application No. 097140278, filed on Oct. 21, 2008, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a deploy apparatus, a method and a computer program product thereof for a wireless network. In particularly, the present invention relates to a deploy apparatus, a method and a computer program product thereof for adjusting the number of network nodes in a wireless network.

2. Descriptions of the Related Art

Current wireless network schemes fall into the following categories based on communication ranges: the Wireless Wide Area Network (WWAN) wireless network, the Wireless Metropolitan Area Network (WMAN) wireless network, the Wireless Local Area Network (WLAN) wireless network, the Bluetooth wireless network, the Infrared (IR) wireless network and various other wireless network standards. Among the various wireless network standards, the WLAN has the widest application in daily life. Some examples are WLAN access points (APs) without physical wiring and WLAN wireless network cards for use in home computers.

A wireless network has higher flexibility than a wired network in terms of both deployment and use. Meanwhile, the use of the wireless network may also substantially reduce the cost of manpower and materials associated with the conventional wired network. However, albeit these advantages, the wireless network still suffers from a number of limitations, such as unstable data transmission range, low data transmission security, low data transmission speed, etc.

To overcome the defects of the wireless network mentioned above, a number of wireless network nodes are typically installed in this space to form a wireless network with an effective coverage adequate to cover this space when deploying a wireless network in a space. However, it is important to properly and completely deploy the wireless network and make all the wireless network nodes capable of transmitting data between each other to ensure data transmission to any location within the space.

Accordingly, the appropriate arrangement of wireless network nodes in a space needs to be considered in wireless network deployment so that the following can occur: the wireless network nodes are capable of transmitting data between each other; computations needed for the deployment are reduced to shorten the time needed for deployment; and finally, the wireless network nodes can be re-arranged when changes occur to the size of the space or the number of wireless network nodes to maximize the effective coverage of the wireless network.

### SUMMARY OF THE INVENTION

One objective of this invention is to provide a deploy method for a wireless network, wherein the wireless network has at least one first network node. The deploy method comprises the following steps: calculating a node constant according to a first default value, and a second default value; calculating an output constant according to the second default value and a third default value; calculating a first evaluation function according to the related information of the at least one first network node and a signal coverage of the wireless network; determining that the output constant is not smaller than one; retrieving a test value, wherein the test value falls within a range from zero to one; determining that the test value is smaller than the node constant; adding a second network node into the wireless network; calculating a second evaluation function according to the related information of the at least one first network node, related information of the second network node, and the signal coverage of the wireless network after the second network node is added; and comparing the first evaluation function and the second evaluation function to deploy the wireless network, wherein the first default value is substantially bigger than the second default value, and the second default value is substantially bigger than the third default value.

Another objective of this invention is to provide a deploy method for a wireless network, wherein the wireless network has a first network node and a second network node located at a first position. The deploy method comprises the following steps: calculating a node constant according to a first default value, and a second default value; calculating an output constant according to the second default value and a third default value; calculating a first evaluation function according to the related information of the first network node, related information of the second network node, and a signal coverage of the wireless network; determining that the output constant is not smaller than one; retrieving a test value, wherein the test value falls within a range of zero to one; determining that the test value is smaller than the node constant; moving the second network node to a second position or removing the second network node; calculating a second evaluation function according to the related information of the first network node and/or the related information of the second network node, and the signal coverage of the wireless network after the second network node is moved to the second position or removed; and comparing the first evaluation function with the second evaluation function to deploy the wireless network, wherein the first default value is substantially bigger than the second default value, and the second default value is substantially bigger than the third default value.

This invention further provides a computer program product stored in a computer readable medium for a deploy apparatus to perform the deploy method in a wireless network.

Yet a further objective of this invention is to provide a deploy apparatus for use in a wireless network with at least one first network node. The deploy apparatus comprises a calculating module, a processing module and a retrieval module. The calculating module is configured to calculate a node constant according to a first default value, and a second default value, to calculate an output constant according to the second default value and a third default value, and to calculate a first evaluation function according to the related information of the at least one first network node and a signal coverage of the wireless network. The processing module is configured to determine whether the output constant is not smaller than one. The retrieval module is configured to retrieve a test value when the output constant is not smaller than one, wherein the first default value is substantially bigger than the second default value, and the second default value is substantially bigger than the third default value, wherein the test value falls within a range from zero to one. The processing module further determines whether the test value is smaller than the node constant, and adds a second network node into the wireless network when the test value is smaller than the node constant. The calculating module calculates a second evaluation function according to the related information of the at least one first network node, related information of the second network node, and the signal coverage of the wireless network after the second network node is added. Finally, the processing module compares the first evaluation with the second evaluation function to deploy the wireless network.

Still another objective of this invention is to provide a deploy apparatus for use in a wireless network with a first network node and a second network node located at the first position. The deploy apparatus comprises a calculating module, a processing module and a retrieval module. The calculating module is configured to calculate a node constant according to a first default value, and a second default value, to calculate an output constant according to the second default value and a third default value, and to calculate a first evaluation function according to related information of the first network node, related information of the second network node and a signal coverage of the wireless network. The processing module is configured to determine whether the output constant is not smaller than one. The retrieval module is configured to retrieve the test value when the output constant is not smaller than one, wherein the first default value is substantially bigger than the second default value, and the second default value is substantially bigger than the third default value, wherein the test value falls within a range from zero to one. The processing module further determines whether the test value is smaller than the node constant, and moves the second network node to the second position or removes the second network node when the test value is smaller than the node constant. The calculating module calculates a second evaluation function according to the related information of the first network node and/or the related information of the second network node, and the signal coverage of the wireless network after the second network node is moved to the second position or removed. The processing module compares the first evaluation with the second evaluation function to deploy the wireless network.

This invention calculates deployment sites of individual network nodes in a wireless network in a two-phase deployment approach. After the phase in which the wireless network node is added into the space is completed, the other phase is further launched to move or remove the wireless network nodes already deployed in an optimized way to achieve an appropriate trade-off between the effective coverage of the wireless network and the number of wireless network nodes. This helps to avoid the deployment of an excessive number of wireless network nodes to maximize the effective coverage of the wireless network, which would otherwise incur increased costs of the wireless network deployment.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first embodiment of this invention;

FIG. 2 is a schematic view of a space of the first embodiment;

FIG. 3 is a schematic view of the space after a network node is added therein;

FIG. 4 is a schematic view of the space after a network node is moved therein;

FIG. 5 is a schematic view of the space after a network node is removed therein;

FIG. 6 is a flowchart of a second embodiment of this invention;

FIG. 7 is a flowchart of a third embodiment of this invention; and

FIG. 8 is a flowchart of a fourth embodiment of this invention.

### DESCRIPTION OF THE PREFERRED EMBODIMENT

In the following description, embodiments will be described to explain this invention, which relates to a deploy apparatus, a method and a computer program product thereof for a wireless network. The wireless network described in this invention is deployed in two phases, namely, a growing phase and an optimization phase respectively. During the growing phase, the wireless network is deployed by adding wireless network nodes; and during the optimization phase, the wireless network is deployed by moving or removing wireless network nodes. However, these embodiments are not intended to limit this invention to any specific environment, applications or particular implementations described in these embodiments. Therefore, the description of these embodiments is only for purposes of illustration rather than limitation. It should be appreciated that in the following embodiments and the attached drawings, the elements not related directly to this invention are omitted from depiction.

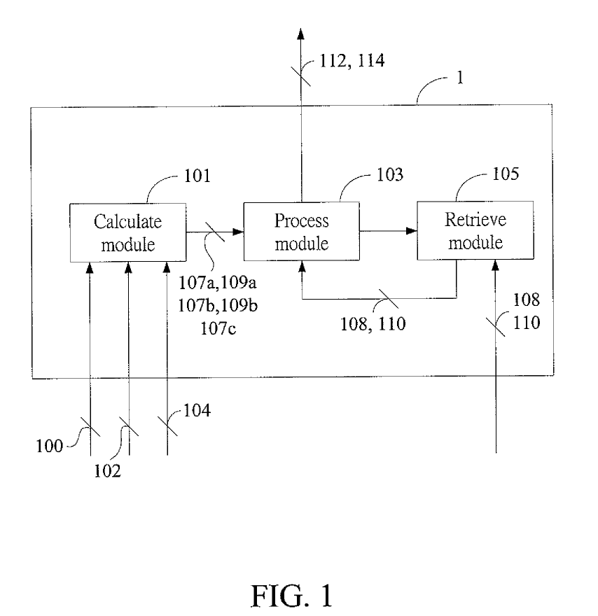

FIG. 1 depicts the first embodiment of this invention, which is a deploy apparatus 1 for deploying a wireless network in a space. The wireless network may be one that conforms to various specifications, e.g., the IEEE 802.11, IEEE 802.16 or IEEE 802.15.4 (ZigBee) standards. The deploy apparatus 1 comprises a calculating module 101, a processing module 103 and a retrieval module 105. The calculating module 101 is configured to calculate an output constant 107a and a node constant 109a according to a first default value 100, a second default value 102 and a third default value 104.

The first default value 100, the second default value 102 and the third default value 104 are an initial constant, a current constant and an end constant respectively for use as limitations on whether or not the deploy apparatus 1 shall output a deployment result. These default values are set in such a way that the first default value 100 is greater than the second default value 102 and the second default value 102 is in turn greater than the third default value 104. These default values shall be preset by a user. In this embodiment, the first default value 100 is set to be 4, the second default value 102 is set to be 3 and the third default value 104 is set to be 2. It should be appreciated that the concrete values described above for the default values are only provided for purposes of illustration rather than to limit this invention.

The first default value 100 and the third default value 104 represent a range of the number of calculations performed by the deploy apparatus 1, so they are set to be constant values that don't vary with the number of calculations performed by the deploy apparatus 1. On the other hand, the second default value 102 varies with the number of calculations performed by the deploy apparatus 1. In this embodiment, the second default value 102 decrements by 0.6 with each calculation performed by the deploy apparatus 1.

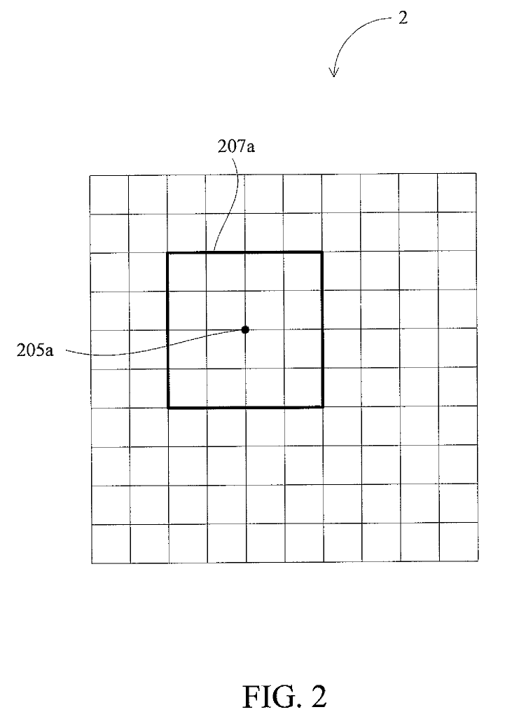

FIG. 2 is a schematic view of a space 2. The space 2 may be divided into a plurality of sub-spaces by a plurality of grid lines, and in this embodiment, is divided into 100 sub-spaces. In the space 2 shown in FIG. 2, a first network node 205a has already been deployed. The first network node 205a has related information, which is a three-dimensional (3D) radio frequency (RF) signal radiation pattern and a signal strength of the first network node 205a. From the related information of the first network node 205a, a first signal coverage 207a of the first network node 205a can be known. The first signal coverage 207a is a portion of the effective coverage of the wireless network. For example, the first signal coverage 207a covers 16 sub-spaces of the space 2, so a wireless network with the first network node 205a has an effective coverage of 16 sub-spaces. In the space 2, a first evaluation function of the wireless network with the first network node 205a is calculated by the calculating module 101 to be 16/100 according to the related information of the first network node 205a and the effective coverage of the wireless network.

The output constant 107a is used to determine whether the deploy apparatus 1 shall output a deployment result. The node constant 109a is used to determine whether to add, move or remove a network node in the wireless network. The calculating module 101 is configured to divide the second default value 102 by the third default value 104 to derive the output constant 107a. According to the respective values described above, the output constant 107a is calculated to be 1.5. Also, the calculating module 101 is configured to divide the second default value by the first default value to derive the node constant 109a. According to the respective values described above, the node constant 109a is calculated to be 0.75.

Then the processing module 103 determines whether the output constant 107a is smaller than 1, and directly outputs the wireless network deployment result (i.e., a wireless network comprising only the first network node 205a) when the output constant 107a is smaller than 1. Because the output constant 107a is 1.5 as described above, the processing module 103 determines that the output constant 107a is not smaller than 1.

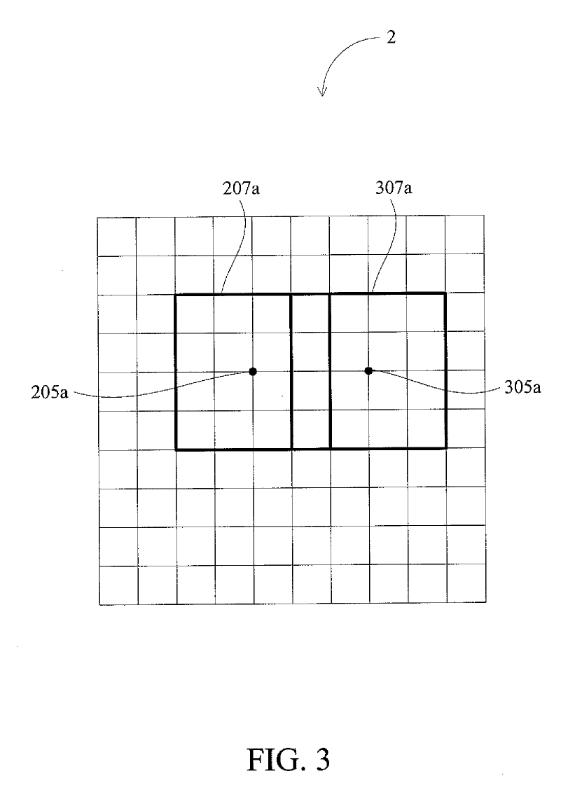

Next, the retrieve module 105 retrieves a test value 108 ranging from 0 to 1, while the processing module 103 further determines whether the test value 108 is smaller than the node constant 109a. In this embodiment, the test value 108 retrieved by the retrieval module 105 is 0.5 while the node constant 109a as described above is 0.75, so the test value 108 is smaller than the node constant 109a. When the deploy apparatus 1 deploys the wireless network in the growing phase, the processing module 103 will add a second network node 305a at a first position in the space 2. The space 2 obtained after the second network node 305a is added at the first position is as depicted in FIG. 3.

The second network node 305a also has related information, which is a 3D RF signal radiation pattern and a signal strength of the second network node 305a. From the related information of the second network node 305a, a second signal coverage 307a of the second network node 305a can be known. In this embodiment, the second signal coverage 307a has an effective range of 16 sub-spaces.

In the space 2 depicted in FIG. 3, the resulting wireless network comprises the first network node 205a and the newly added second network node 305a located at the first position. A second evaluation function of the resulting wireless network is calculated by the calculating module 101 according to the related information of the first network node 205a, the related information of the second network node 305a and the effective coverage of the wireless network. In the wireless network, since the first network node 205a and the second network node 305a located at the first position need to communicate data with each other, the first signal coverage 207a of the first network node 205a and the second signal coverage 307a of the second network node 305a located at the first position are partially overlapped (i.e., at four sub-spaces). Accordingly, the second evaluation function is calculated by the calculating module 101 to be 28/100.

The processing module 103 then compares the first evaluation function with the second evaluation function of the wireless network. As the second evaluation function calculated for the space 2 of FIG. 3 is greater than the first evaluation function calculated for the space 2 of FIG. 2, the processing module 101 deploys in the space 2 a wireless network comprising the first network node 205a and the second network node 305a located at the first position.

After the processing module 101 has compared the first evaluation function with the second evaluation function, the second default value is decremented to 2.4. Then, the calculating module 101 calculates an output constant 107b and a node constant 109b anew according to the decremented second default value. Here, according to the decremented second default value, the output constant 107b is calculated to be 1.2 and the node constant 109b to be 0.6.

Then the processing module 103 determines whether the output constant 107b is smaller than 1, and directly outputs the wireless network deployment result (i.e., a wireless network comprising the first network node 205a and the second network node 305a located at the first position) when the output constant 107b is smaller than 1. Because the output constant 107b is 1.2 as described above, the processing module 103 determines that the output constant 107b is not smaller tan 1.

Next, the retrieval module 105 again retrieves a test value 110 ranging from 0 to 1, while the processing module 103 further determines whether the test value 110 is smaller than the node constant 109b. In this embodiment, the test value 110 retrieved by the retrieval module 105 is 0.55 while the node constant 109b as described above is 0.6, so the test value 110 is smaller than the node constant 109b. When the deploy apparatus 1 deploys the wireless network during the optimization phase, the processing module 103 will accomplish the deployment in two ways during the optimization phase: one is to move a network node, and the other is to remove a network node. Hereinafter, the way in which a network node is moved and a way in which a network node is removed will be described in detail.

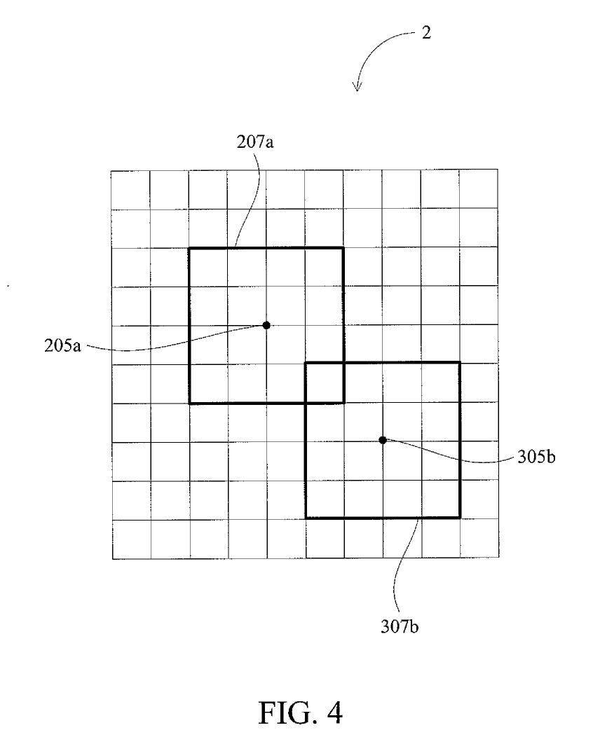

If deployment during the optimization phase is accomplished by moving a network node, the processing module 103 moves the second network node 305a located at the first position to a second position. The space 2 with the second network node 305b moved to the second position is as depicted in FIG. 4.

In the space 2 depicted in FIG. 4, the resulting wireless network comprises the first network node 205a and the second network node 305b located at the second position. A third evaluation function of the resulting wireless network is calculated by the calculating module 101 according to the related information of the first network node 205a, related information of the second network node 305b and the effective coverage of the wireless network. In the wireless network, the first signal coverage 207a of the first network node 205a and the second signal coverage 307b of the second network node 305b located at second first position are still partially overlapped (i.e., at one sub-spaces). Accordingly, the third evaluation function of the wireless network is calculated by the calculating module 101 to be 31/100.

The processing module 103 then compares the second evaluation function with the third evaluation function of the wireless network. Because the third evaluation function calculated for the space 2 of FIG. 4 is greater than the second evaluation function calculated for the space 2 of FIG. 3, the processing module 101 deploys a wireless network comprising the first network node 205a and the second network node 305b in the space 2 located at the second position.

After the processing module 101 has compared the second evaluation function with the third evaluation function, the second default value is decremented to 1.8. Then, the calculating module 101 calculates an output constant 107c anew according to the decremented second default value. Here, according to the decremented second default value, the output constant 107c is calculated to be 0.9.

Then, the processing module 103 determines whether the output constant 107c is smaller than 1, and directly outputs the wireless network deployment result (i.e., a wireless network comprising the first network node 205a and the second network node 305b located at the second position) when the output constant 107c is smaller than 1. Because the output constant 107c is 0.9 as described above, the processing module 103 directly outputs the deployment result 112 as depicted in FIG. 4, i.e., the wireless network comprising the first network node 205a and the second network node 305b located at the second position.

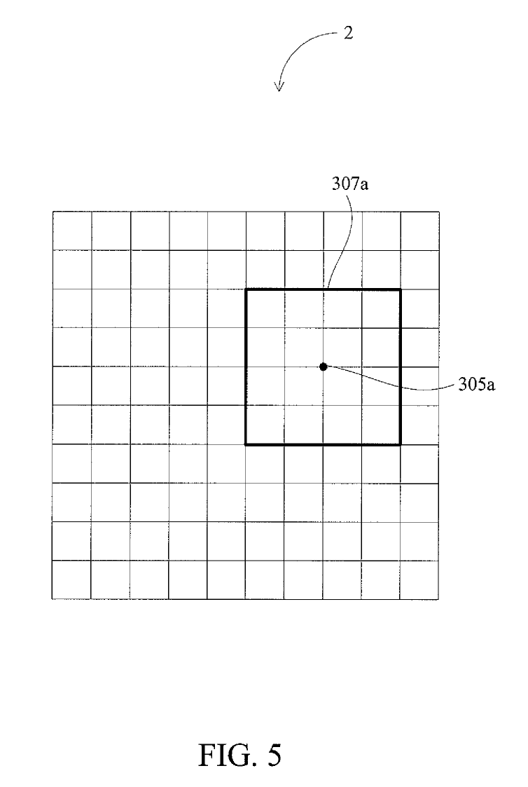

If deployment during the optimization phase is accomplished by removing a network node, the processing module 103 may choose to remove the first network node 205a or the second network node 305a located at the first position. In this embodiment, the processing module 103 chooses to remove the first network node 205a. The space 2 with the first network node 205a being removed is as depicted in FIG. 5.

In the space 2 depicted in FIG. 5, the resulting wireless network only comprises the second network node 305b located at the first position. The fourth evaluation function of the resulting wireless network is calculated by the calculating module 101 to be 16/100 according to the related information of the second network node 305a and the effective coverage of the wireless network.

Once the fourth evaluation function is calculated, the processing module 103 proceeds to compare the second evaluation function with the fourth evaluation function of the wireless network. Because the fourth evaluation function calculated for the space 2 of FIG. 5 is smaller than the second evaluation function calculated for the space 2 of FIG. 3, the processing module 101 still deploys the wireless network comprising the first network node 205a and the second network node 305a in the space 2 located at the first position.

After the processing module 101 has compared the second evaluation function with the fourth evaluation function, the second default value is decremented to 1.8. Then, the calculating module 101 calculates an output constant 107c anew according to the decremented second default value. Here, according to the decremented second default value, the output constant 107c is calculated to be 0.9.

Then, the processing module 103 determines whether the output constant 107c is smaller than 1, and directly outputs the wireless network deployment result (i.e., a wireless network comprising the first network node 205a and the second network node 305a located at the first position) when the output constant 107c is smaller than 1. Because the output constant 107c is 0.9 as described above, the processing module 103 directly outputs the deployment result 114 as depicted in FIG. 3, i.e., the wireless network comprising the first network node 205a and the second network node 305a located at the first position.

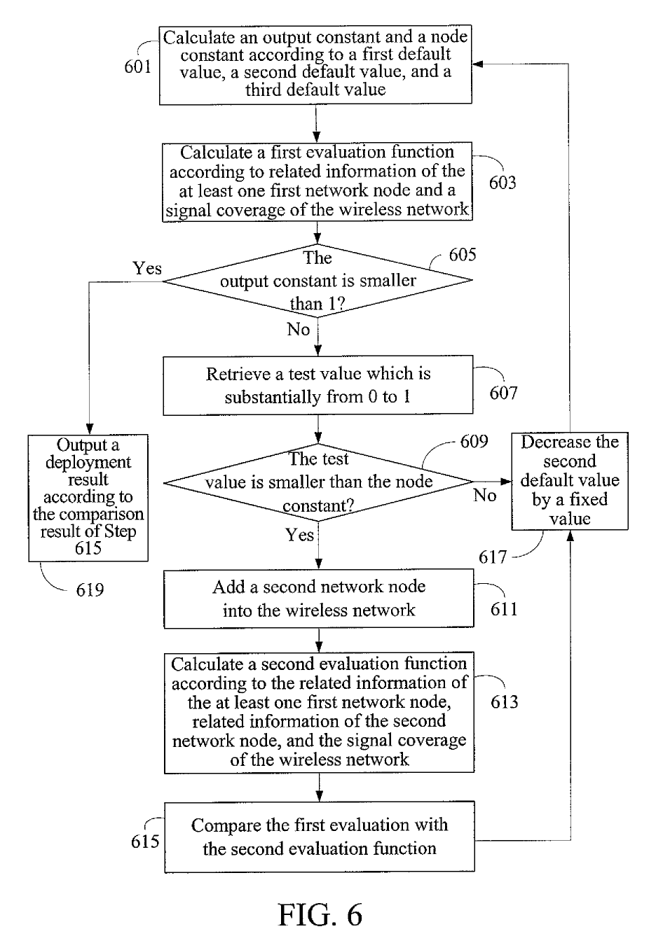

FIG. 6 depicts a second embodiment of this invention, which is a deploy method for a wireless network. This deploy method is adapted for an apparatus, e.g., the deploy apparatus 1 described in the first embodiment. The wireless network already has at least one first network node. More specifically, the deploy method described in the second embodiment is a deploy method for the growing phase, and may be implemented by a computer program product. When the computer program product is loaded into the deploy apparatus 1 via a computer and a plurality of program instructions embodied thereon is executed, the deploy method of the second embodiment can be accomplished. This computer program product may be stored in a tangible machine-readable medium, such as an ROM, a flash memory, a floppy disk, a hard disk, a compact disk, a mobile disk, a magnetic tape, a database accessible to networks, or any other storage media with the same function and well known to those skilled in the art.

The deploy method of the second embodiment comprises the following steps. Initially in Step 601, an output constant and a node constant are calculated according to a first default value, a second default value, and a third default value. The first default value is substantially greater than the second default value, which is in turn substantially greater than the third default value. Then in Step 603, a first evaluation function is calculated according to related information of the at least one first network node and a signal coverage of the wireless network. In Step 605, it is determined whether the output constant is smaller than one.

If the output constant is not smaller than one, a test value is retrieved in Step 607, wherein the test value is substantially from zero to one. Next in Step 609, it is determined whether the test value is smaller than the node constant. If the test value is smaller than the node constant, a second network node is added into the wireless network in Step 611. Next in Step 613, a second evaluation function is calculated according to the related information of the at least one first network node, related information of the second network node, and the signal coverage of the wireless network. Subsequently, the first evaluation and the second evaluation function are compared against each other in Step 615. If the second evaluation function is greater than the first evaluation function, the at least one first network node and the second network node are deployed in the wireless network; on the other hand, if the first evaluation function is greater than the second evaluation function, the at least one first network node is deployed in the wireless network without adding the second network node.

Then, the second default value is decremented by a fixed value in Step 617, and an output constant and a node constant are calculated anew in Step 601. If it is determined in Step 609 that the test value is greater than the node constant, the process proceeds to Step 617. If it is determined in Step 605 that the output constant is smaller than 1, the process proceeds to Step 619 where a wireless network deployment result is outputted according to the comparison result of Step 615.

In addition to the aforesaid steps, the second embodiment can also execute the operations and functions described with respect to the deploy apparatus 1 in the first embodiment. How the second embodiment executes these operations and functions based on the explanation of the first embodiment will be readily appreciated by those of ordinary skill in the art, and thus will not be further described herein.

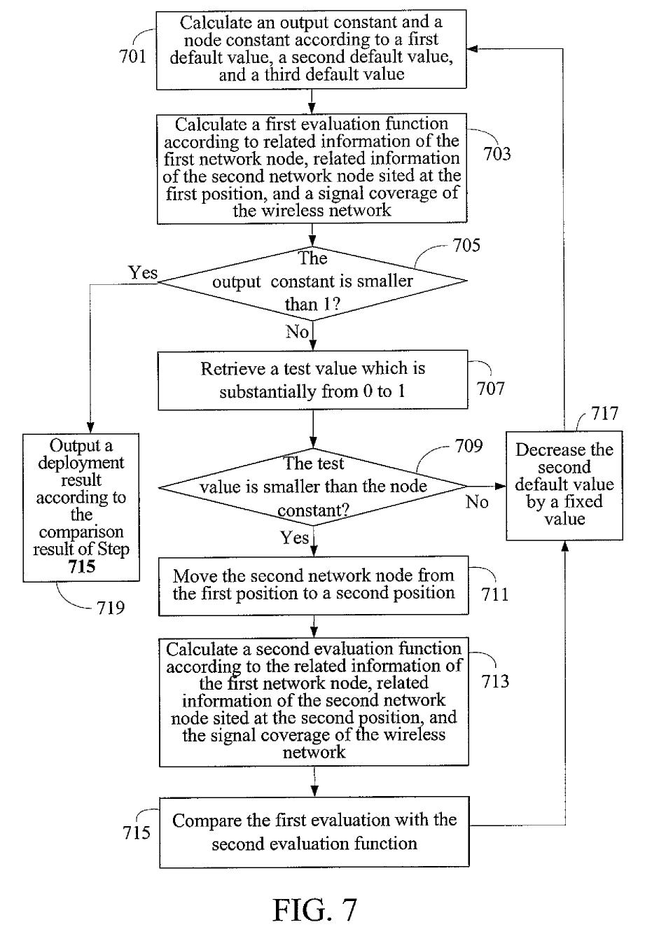

FIG. 7 depicts a third embodiment of this invention, which is a deploy method for a wireless network. This deploy method is adapted for an apparatus, e.g., the deploy apparatus 1 described in the first embodiment. The wireless network already has a first network node and a second network node located at a first position. More specifically, the deploy method described in the third embodiment is a deploy method that moves a network node during the optimization phase, and may be implemented by a computer program product. When the computer program product is loaded into the deploy apparatus 1 via a computer and a plurality of program instructions embodied thereon is executed, the deploy method of the third embodiment can be accomplished. This computer program product may be stored in a tangible machine-readable medium, such as an ROM, a flash memory, a floppy disk, a hard disk, a compact disk, a mobile disk, a magnetic tape, a database accessible to networks, or any other storage media with the same function and well known to those skilled in the art.

The deploy method of the third embodiment comprises the following steps. Initially in Step 701, an output constant and a node constant are calculated according to a first default value, a second default value, and a third default value. The first default value is substantially greater than the second default value, which is in turn substantially greater than the third default value. Then in Step 703, a first evaluation function is calculated according to related information of the first network node, related information of the second network node located at the first position, and a signal coverage of the wireless network. In Step 705, it is determined whether the output constant is smaller than one.

If the output constant is not smaller than one, a test value is retrieved in Step 707, wherein the test value is substantially from zero to one. Next in Step 709, it is determined whether the test value is smaller than the node constant. If the test value is smaller than the node constant, the second network node is moved from the first position to a second position in Step 711. Next in Step 713, a second evaluation function is calculated according to the related information of the first network node, related information of the second network node located at the second position, and the signal coverage of the wireless network. Subsequently, the first evaluation and the second evaluation function are compared against each other in Step 715. If the second evaluation function is greater than the first evaluation function, the first network node and the second network node located at the second position are deployed in the wireless network. On the other hand, if the first evaluation function is greater than the second evaluation function, the first network node and the second network node located at the first position are deployed in the wireless network.

Then, the second default value is decremented by a fixed value in Step 717, and an output constant and a node constant are calculated again in Step 701. If it is determined in Step 709 that the test value is greater than the node constant, the process proceeds to Step 717. If it is determined in Step 705 that the output constant is smaller than one, the process proceeds to Step 719 where a wireless network deployment result is outputted according to the comparison result of Step 715.

In addition to the aforesaid steps, the third embodiment can also execute the operations and functions described with respect to the deploy apparatus 1 in the first embodiment. The methods in which the third embodiment executes these operations and functions based on the explanation of the first embodiment will be readily appreciated by those of ordinary skill in the art, and thus will not be further described herein.

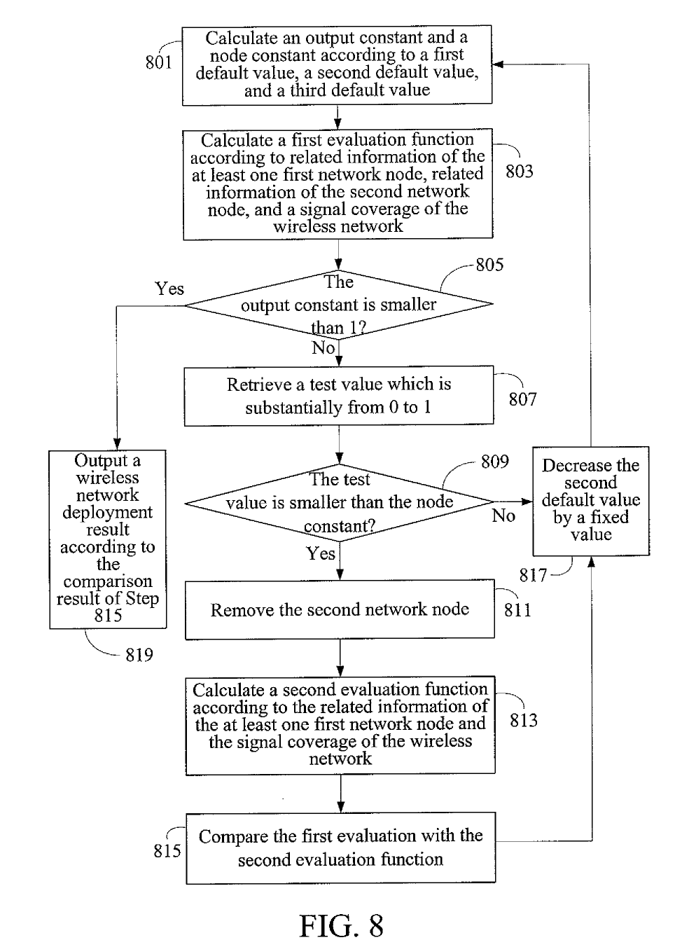

FIG. 8 depicts a fourth embodiment of this invention, which is a deploy method for a wireless network. This deploy method is adapted for an apparatus, e.g., the deploy apparatus 1 described in the first embodiment. The wireless network already has at least one first network node and a second network node. More specifically, the deploy method described in the fourth embodiment is a deploy method that removes a network node during the optimization phase, and may be implemented by a computer program product. When the computer program product is loaded into the deploy apparatus 1 via a computer and a plurality of program instructions embodied thereon is executed, the deploy method of the fourth embodiment can be accomplished. This computer program product may be stored in a tangible machine-readable medium, such as an ROM, a flash memory, a floppy disk, a hard disk, a compact disk, a mobile disk, a magnetic tape, a database accessible to networks, or any other storage media with the same function and well known to those skilled in the art.

The deploy method of the fourth embodiment comprises the following steps. Initially in Step 801, an output constant and a node constant are calculated according to the first default value, a second default value, and a third default value. The first default value is substantially greater than the second default value, which is in turn substantially greater than the third default value. Then, in Step 803, a first evaluation function is calculated according to the related information of the first network node, related information of the second network node, and a signal coverage of the wireless network. In Step 805, it is determined whether the output constant is smaller than one.

If the output constant is not smaller than one, a test value is retrieved in Step 807, wherein the test value is substantially from zero to one. Next in Step 809, it is determined whether the test value is smaller than the node constant. If the test value is smaller than the node constant, the second network node is removed in Step 811. Next in Step 813, a second evaluation function is calculated according to the related information of the first network node and the signal coverage of the wireless network. Subsequently, the first evaluation and the second evaluation function are compared against each other in Step 815. If the second evaluation function is greater than the first evaluation function, the first network node is deployed in the wireless network. On the other hand, if the first evaluation function is greater than the second evaluation function, the first network node and the second network node are deployed in the wireless network.

Then, the second default value is decremented by a fixed value in Step 817, and an output constant and a node constant are calculated again in Step 801. If it is determined in Step 809 that the test value is greater than the node constant, the process proceeds to Step 817. If it is determined in Step 805 that the output constant is smaller than one, the process proceeds to Step 819 where a wireless network deployment result is outputted according to the comparison result of Step 815.

In addition to the aforesaid steps, the fourth embodiment can also execute the operations and functions described with respect to the deploy apparatus 1 in the first embodiment. The methods in which the fourth embodiment executes these operations and functions based on the explanation of the first embodiment will be readily appreciated by those of ordinary skill in the art, and thus will not be further described herein.

The deploy apparatus 1 of this invention calculates deployment sites of individual wireless network nodes of a wireless network in a two-phase deployment approach. After a growing phase in which a wireless network node is added into a space is completed, the other phase is further launched to move or remove the wireless network nodes already deployed in an optimized way, thereby achieving an appropriate trade-off between the effective coverage of the wireless network and the number of wireless network nodes. This helps to avoid deployment of an excessive number of wireless network nodes to maximize the effective coverage of the wireless network, which would otherwise incur increased costs to the wireless network deployment.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A deploy method for a wireless network, the wireless network having at least one first network node, the deploy method comprising the steps of:
(a) calculating a node constant according to a first default value and a second default value;
(b) calculating an output constant according to the second default value and a third default value;
(c) calculating a first evaluation function according to related information of the at least one first network node and a signal coverage of the wireless network;
(d) determining that the output constant is not smaller than one;
(e) retrieving a test value, wherein the test value falls within a range from zero to one;
(f) determining that the test value is smaller than the node constant;
(g) adding a second network node into the wireless network;
(h) calculating a second evaluation function according to the related information of the at least one first network node, related information of the second network node, and the signal coverage of the wireless network; and
(i) comparing the first evaluation and the second evaluation function to deploy the wireless network;
wherein the first default value is substantially bigger than the second default value, and the second default value is substantially bigger than the third default value.

2. The deploy method of claim 1, wherein the step(i) further comprises the steps of:
(i1) determining that the output constant is smaller than one; and
(i2) deploying the wireless network according to the comparative result of the first evaluation function and the second evaluation function.

3. The deploy method of claim 2, further comprising the step of:
(j) deploying the at least one first network node as the wireless network when the first evaluation function is bigger than the second evaluation function.

4. The deploy method of claim 2, further comprising the step of:
(j) deploying the at least one first network node and the second network node as the wireless network when the second evaluation function is bigger than the first evaluation.

5. A computer program product stored in a computer readable medium for a deploy apparatus to perform a deploy method, the deploy apparatus being use for a wireless network having at least one first network node, the computer program product comprising:
a first code for a calculating module to calculate a node constant according to a first default value and a second default value, and to calculate an output constant according to the second default value and a third default value;
a second code for the calculating module to calculate a first evaluation function according to related information of the at least one first network node and a signal coverage of the wireless network;
a third code for a processing module to determine that the output constant is not smaller than one;
a fourth code for a retrieval module to retrieve a test value, wherein the test value falls within a range from zero to one;
a fifth code for the processing module to determine that the test value is smaller than the node constant;
a sixth code for the processing module to add a second network node into the wireless network;
a seventh code for the calculating module to calculate a second evaluation function according to the related information of the at least one first network node, related information of the second network node, and the signal coverage of the wireless network; and
an eighth code for the processing module to compare the first evaluation and the second evaluation function to deploy the wireless network;
wherein the first default value is substantially bigger than the second default value, and the second default value is substantially bigger than the third default value.

6. The computer program product of claim 5, wherein the eighth code further comprises:
a ninth code for the processing module to determine that the output constant is smaller than one; and
a tenth code for the processing module to deploy the wireless network according to the comparative result of the first evaluation and the second evaluation function.

7. The computer program product of claim 6, further comprising:
an eleventh code for the processing module to deploy at least one first network node as the wireless network when the first evaluation function is bigger than the second evaluation function.

8. The computer program product of claim 6, further comprising:
an eleventh code for the processing module to deploy the at least one first network node and the second network node as the wireless network when the second evaluation function is bigger than the first evaluation.

9. A deploy method for a wireless network, the wireless network having a first network node and a second network node located on a first position, the deploy method comprising the steps of:
(a) calculating a node constant according to a first default value and a second default value;
(b) calculating an output constant according to the second default value and a third default value;
(c) calculating a first evaluation function according to related information of the first network node, related information of the second network node, and a signal coverage of the wireless network;
(d) determining that the output constant is not smaller than one;
(e) retrieving a test value, wherein the test value falls within a range from zero to one;
(f) determining that the test value is smaller than the node constant;
(g) moving the second network node to a second position;
(h) calculating a second evaluation function according to the related information of the first network node, the related information of the second network node, and the signal coverage of the wireless network after removing the second network node; and
(i) comparing the first evaluation and the second evaluation function to deploy the wireless network;
wherein the first default value is substantially bigger than the second default value, and the second default value is substantially bigger than the third default value.

10. The deploy method of claim 9, wherein the step(i) further comprises the steps of:
(i1) determining that the output constant is smaller than one; and
(i2) deploying the wireless network according to the comparative result of the first evaluation function and the second evaluation function.

11. The deploy method of claim 10, further comprising the step of:
(j) deploying the first network node and the second network node located on the first position as the wireless network when the first evaluation function is bigger than the second evaluation function.

12. The deploy method of claim 10, further comprising the step of:
(j) deploying the first network node and the second network node located on the second position as the wireless network when the second evaluation function is bigger than the first evaluation.

13. A computer program product stored in a computer readable medium for a deploy apparatus to perform a deploy method, the deploy apparatus being use for a wireless network having a first network node and a second network node located on a first position, the computer program product comprising:
a first code for a calculating module to calculate a node constant according to a first default value and a second default value, and to calculate an output constant according to the second default value and a third default value;
a second code for the calculating module to calculate a first evaluation function according to related information of the first network node, related information of the second network node, and a signal coverage of the wireless network;
a third code for a processing module to determine that the output constant is not smaller than one;
a fourth code for a retrieval module to retrieve a test value, wherein the test value falls within a range from zero to one;
a fifth code for the processing module to determine that the test value is smaller than the node constant;
a sixth code for the processing module to move the second network node to a second position;
a seventh code for the calculating module to calculate a second evaluation function according to the related information of the first network node, the related information of the second network node, and the signal coverage of the wireless network after the second network node has moved to the second position; and
an eighth code for the processing module to compare the first evaluation and the second evaluation function to deploy the wireless network;
wherein the first default value is substantially bigger than the second default value, and the second default value is substantially bigger than the third default value.

14. The computer program product of claim 13, wherein the eighth code further comprises:
a ninth code for the processing module to determine that the output constant is smaller than one; and
a tenth code for the processing module to deploy the wireless network according to the comparative result of the first evaluation and the second evaluation function.

15. The computer program product of claim 14, further comprising:
an eleventh code for the processing module to deploy the first network node and the second network node located on the first position as the wireless network when the first evaluation function is bigger than the second evaluation function.

16. The computer program product of claim 14, further comprising:
an eleventh code for the processing module to deploy the first network node and the second network node located on the second position as the wireless network when the second evaluation function is bigger than the first evaluation.

17. A deploy method for a wireless network, the wireless network having at least one first network node and a second network node, the deploy method comprising the steps of:
(a) calculating a node constant according to a first default value and a second default value;
(b) calculating an output constant according to the second default value and a third default value;
(c) calculating a first evaluation function according to related information of the at least one first network node, related information of the second network node, and a signal coverage of the wireless network;
(d) determining that the output constant is not smaller than one;
(e) retrieving a test value, wherein the test value falls within a range from zero to one;
(f) determining that the test value is smaller than the node constant;
(g) removing the second network node;
(h) calculating a second evaluation function according to the related information of the at least one first network node and the signal coverage of the wireless network; and
(i) comparing the first evaluation and the second evaluation function to deploy the wireless network;
wherein the first default value is substantially bigger than the second default value, and the second default value is substantially bigger than the third default value.

18. The deploy method of claim 17, wherein the step(i) further comprises the steps of:
(i1) determining that the output constant is smaller than one; and
(i2) deploying the wireless network according to the comparative result of the first evaluation function and the second evaluation function.

19. The deploy method of claim 18, further comprising the step of:
(j) deploying the at least one first network node and the second network node as the wireless network when the first evaluation function is bigger than the second evaluation function.

20. The deploy method of claim 18, further comprising the step of:
(j) deploying the at least one first network node as the wireless network when the second evaluation function is bigger than the first evaluation

21. A computer program product stored in a computer readable medium for a deploy apparatus to perform a deploy method, the deploy apparatus being use for a wireless network having at least one first network node, and a second network node, the computer program product comprising:
a first code for a calculating module to calculate a node constant according to a first default value and a second default value, and to calculate an output constant according to the second default value and a third default value;
a second code for the calculating module to calculate a first evaluation function according to related information of the at least one first network node, related information of the second network node, and a signal coverage of the wireless network;
a third code for a processing module to determine that the output constant is not smaller than one;
a fourth code for a retrieval module to retrieve a test value, wherein the test value falls within a range from zero to one;
a fifth code for the processing module to determine that the test value is smaller than the node constant;
a sixth code for the processing module to remove the second network node;
a seventh code for the calculating module to calculate a second evaluation function according to the related information of the at least one first network node, and the signal coverage of the wireless network after removing the second network node; and
an eighth code for the processing module to compare the first evaluation and the second evaluation function to deploy the wireless network;
wherein the first default value is substantially bigger than the second default value, and the second default value is substantially bigger than the third default value.

22. The computer program product of claim 21, wherein the eighth code further comprises:
a ninth code for the processing module to determine that the output constant is smaller than one; and
a tenth code for the processing module to deploy the wireless network according to the comparative result of the first evaluation and the second evaluation function.

23. The computer program product of claim 22, further comprising:
an eleventh code for the processing module to deploy the at least one first network node and the second network node as the wireless network when the first evaluation function is bigger than the second evaluation function.

24. The computer program product of claim 22, further comprising:
an eleventh code for the processing module to deploy the at least one first network node as the wireless network when the second evaluation function is bigger than the first evaluation.

25. A deploy apparatus being use for a wireless network having at least one first network node, the deploy apparatus comprising:
a calculating module, being configured to calculate a node constant according to a first default value and a second default value, to calculate an output constant according to the second default value and a third default value, and to calculate a first evaluation function according to related information of the at least one first network node and a signal coverage of the wireless network;
a processing module, being configured to determine whether the output constant is not smaller than one; and
a retrieval module, being configured to retrieve a test value when the output constant is not smaller than one, wherein the test value falls within a range from zero to one;
wherein the first default value is substantially bigger than the second default value, and the second default value is substantially bigger than the third default value; and
wherein the processing module further determines whether the test value is smaller than the node constant, and adds a second network node into the wireless network when the test value is smaller than the node constant, the calculating module calculates a second evaluation function according to the related information of the at least one first network node, related information of the second network node, and the signal coverage of the wireless network, the processing module compares the first evaluation and the second evaluation function to deploy the wireless network.

26. The deploy apparatus of claim 25, wherein the processing module deploys the wireless network according to the comparative result of the first evaluation function and the second evaluation function when the output constant is smaller than one.

27. The deploy apparatus of claim 26, wherein the processing module deploys the at least one first network node as the wireless network when the first evaluation function is bigger than the second evaluation function.

28. The deploy apparatus of claim 26, wherein the processing module deploys the at least one first network node and the second network node say the wireless network when the second evaluation function is bigger than the first evaluation.

29. The deploy apparatus of claim 25, wherein the related information of the at least one first network node is one of s 3D RF signal radiation pattern and a signal strength of the at least one first network node, and the related information of the second network node is one of s 3D RF signal radiation pattern and a signal strength of the second network node.

30. A deploy apparatus being use for a wireless network having a first network node and a second network node located on a first position, the deploy apparatus comprising:
a calculating module, being configured to calculate a node constant according to a first default value and a second default value, to calculate an output constant according to the second default value and a third default value, and to calculate a first evaluation function according to related information of the first network node, related information of the second network node, and a signal coverage of the wireless network;
a processing module, being configured to determine whether the output constant is not smaller than one; and
a retrieval module, being configured to retrieve a test value when the output constant is not smaller than one, wherein the test value falls within a range from zero to one;
wherein the first default value is substantially bigger than the second default value, and the second default value is substantially bigger than the third default value; and
wherein the processing module further determines whether the test value is smaller than the node constant, the processing module moves the second network node to a second position when the test value is smaller than the node constant, the calculating module calculates a second evaluation function according to the related information of the first network node, the related information of the second network node, and the signal coverage of the wireless network after moving the second network node, the processing module compares the first evaluation and the second evaluation function to deploy the wireless network.

31. The deploy apparatus of claim 30, wherein the processing module deploys the wireless network according to the comparative result of the first evaluation function and the second evaluation function when the output constant is smaller than one.

32. The deploy apparatus of claim 31, wherein the processing module deploys the first network node and the second network node located on the first position as the wireless network when the first evaluation function is bigger than the second evaluation function.

33. The deploy apparatus of claim 31, wherein the processing module deploys the first network node and the second network node located on the second position as the wireless network when the second evaluation function is bigger than the first evaluation.

34. The deploy apparatus of claim 30, wherein the related information of the first network node is one of a 3D RF signal radiation pattern and a signal strength of the first network node, and the related information of the second network node is one of a 3D RF signal radiation pattern and a signal strength of the second network node.

35. A deploy apparatus being use for a wireless network having at least one first network node and a second network node, the deploy apparatus comprising:
a calculating module, being configured to calculate a node constant according to a first default value and a second default value, to calculate an output constant according to the second default value and a third default value, and to calculate a first evaluation function according to related information of the at least one first network node, related information of the second network node, and a signal coverage of the wireless network;
a processing module, being configured to determine whether the output constant is not smaller than one; and
a retrieval module, being configured to retrieve a test value when the output constant is not smaller than one, wherein the test value falls within a range from zero to one;
wherein the first default value is substantially bigger than the second default value, and the second default value is substantially bigger than the third default value; and
wherein the processing module further determines whether the test value is smaller than the node constant, the processing module removes a second network node when the test value is smaller than the node constant, the calculating module calculates a second evaluation function according to the related information of the at least one first network node and the signal coverage of the wireless network, the processing module compares the first evaluation and the second evaluation function to deploy the wireless network.

36. The deploy apparatus of claim 35, wherein the processing module deploys the wireless network according to the comparative result of the first evaluation function and the second evaluation function when the output constant is smaller than one.

37. The deploy apparatus of claim 36, wherein the processing module deploys the at least one first network node and the second network node as the wireless network when the first evaluation function is bigger than the second evaluation function.

38. The deploy apparatus of claim 36, wherein the processing module deploys the at least one first network node as the wireless network when the second evaluation function is bigger than the first evaluation.

39. The deploy apparatus of claim 35, wherein the related information of the at least one first network node is one of a 3D RF signal radiation pattern and a signal strength of the at least one first network node, and the related information of the second network node is one of a 3D RF signal radiation pattern and a signal strength of the second network node.
